(19) United States
(12) Patent Application Publication
(10) Pub. No.: US 2026/0109920 A1
(43) Pub. Date: Apr. 23, 2026

(54) STATIC SOLUTION

(71) Applicant: CARBOTEK SYSTEMS GmbH, Nördlingen (DE)

(72) Inventor: Florian KOCH, Nördlingen (DE)

(21) Appl. No.: 19/359,888

(22) Filed: Oct. 16, 2025

(30) Foreign Application Priority Data
Oct. 18, 2024 (EP) 24 207 447.4

(51) Int. Cl. C12G 1/06; B01F 33/501; C12G 3/04

(52) U.S. Cl. CPC C12G 1/062; B01F 33/5014; C12G 3/04

(57) ABSTRACT

The present invention relates to a beverage preparer, suitable for preparing a beverage from a beverage precursor product that is free of or low in impregnating gas and a number of impregnation gases. The beverage preparer comprises an impregnating gas supply line for supplying the number of impregnating gases and a beverage precursor product supply line for supplying the beverage precursor product to an impregnation arrangement (1), wherein the impregnating gas supply line and the beverage precursor product supply line open into the impregnation arrangement (1) at its inlet or merge upstream of the impregnation arrangement (1) to form a beverage supply line which opens into the impregnation arrangement (1) at its inlet. The beverage further comprises the impregnation arrangement (1) for dissolving the number of impregnating gases in the beverage precursor product to form the beverage, wherein the impregnation arrangement (1) has a number of mixer pipes (2, 3, 4) or mixer hoses arranged in series in the direction of flow, in each of which a number of static mixers (30) is arranged, and at least one tap (10) or an electronically controlled beverage dispenser, which is connected to the impregnation arrangement (1) via a beverage outlet line coming from the outlet side of the impregnation arrangement (1).

The invention relates to a beverage preparer according to the preamble of claim 1. As the name suggests, such beverage preparers are suitable for preparing a beverage, namely from a beverage precursor that is free of or low in impregnating gas and an impregnating gas. In particular, nowadays, spirits or alcoholic mixed drinks such as espresso martinis or cold brew coffee are impregnated with nitrogen to create a nice foam crown, or wine is impregnated with carbon dioxide (more precisely: CO₂) to produce a sparkling wine-like beverage.

Dispenser side beverage preparers of the generic kind have an impregnation gas supply line and a beverage precursor supply line, which converge downstream of an impregnation arrangement to form a beverage supply line leading to the impregnation arrangement, in which the impregnation gas mixed into the beverage precursor is to dissolve in the beverage precursor, so that the beverage is prepared, whereby a beverage outlet line from the impregnation arrangement usually leads to a cooling system or through a flow cooler and then to a tap for dispensing the beverage. The impregnation gas supply line and the beverage precursor supply line can also lead directly into the impregnation arrangement, so that not only is the gas dissolved in the beverage precursor there, but it is also mixed in.

One problem that needs to be solved here is the dosing of the correct amount of impregnation gas per unit volume of beverage precursor. A proposed solution to this problem is already provided by German patent DE 10 2015 010 783 B3.

Another fundamental problem that needs to be solved is the impregnation of the dosed impregnation gas into the beverage precursor, i.e., the dissolution of the gas in the beverage precursor in order to prepare a beverage from the beverage precursor with the dosed impregnation gas, which consists of the beverage precursor and the impregnation gas dissolved therein.

For this purpose, impregnation devices are used in beverage dispensing systems to impregnate beverage precursor products with gases or to dissolve gases in the beverage precursor products, thereby producing ready-to-drink beverages in the dispensing system rather than, for example, in the brewery or at the beverage bottler.

In addition to the specialties mentioned above, examples of liquids to be impregnated include lemonades, syrups of all kinds, cola, juices, cider, wine, soda water, and, in particular, a low-carbonated or non-carbonated beer precursor product, i.e., a beer precursor product with a maximum of 1 gram of CO₂ per liter of liquid. In addition to aromatic gases, carbon dioxide—often referred to as carbonic acid-and nitrogen (more precisely: N₂) are particularly suitable as impregnation gases, but air (compressed air), argon, or helium can also be used, for example, to produce sparkling lemonade and, in particular, carbonated beer. The impregnation of a liquid with CO₂ is referred to as carbonation, which is traditionally the most common application of a relevant beverage dispenser in beverage preparation, although recently nitrogenation at the dispensing end has also become common using generic beverage dispensers.

One advantage of inline impregnation in the dispensing system is that the beverage precursor can be delivered to the dispensing system without or with low overpressure in containers that are not or only partially pressurizable, such as bag-in-box systems, which saves on costs for pressure vessels (e.g., kegs or so-called kegs) and their transport compared to conventional methods in which ready-made beverages are dispensed. costs for pressure vessels (e.g., barrels or kegs) and their transport can be saved. Other beverages can only be produced in this way.

Impregnators that can be used in dispensing systems, also known as inline impregnators because they are installed in the dispensing line, which are in principle also suitable for conventional beverage preparers, can be found, for example, in DE 198 51 360 A1 and U.S. Pat. No. 3,761,066 in the form of tube screen carbonators, in the form of bulk material carbonators in DE 101 06 397 A1 and in the form of a porous solid in European patent specification EP 1 998 878, with impregnating bodies made of hydrophobic hollow fibers, for example in US patent specifications U.S. Pat. Nos. 6,712,342 B2 and 6,138,995, and in the design with a premixing cell of the German patent application DE 10 2008 012 486 A1.

Recently, however, drinks impregnated in dispensing systems or inline have become increasingly popular, which are based on alcohol mixed with relatively viscous fruit pulp containing pieces of fruit or which are based on alcohol mixed with sticky syrups, such as certain nitrogenated cocktails. With such beverages, known impregnators tend to clog, so that the beverage preparer often has to be disassembled and the impregnator replaced. In addition, known beverage impregnators of the above-mentioned type are also relatively expensive, so that, apart from the replacement necessary in the event of clogging, there is also a general need to find cheaper beverage impregnators.

Based on this, it is an object of the present invention to provide a beverage preparer for this purpose, which can be manufactured and operated inexpensively and has low maintenance intervals.

This object is solved by the features of claim 1.

According to the invention, a beverage preparer is provided with an impregnation arrangement comprising a number of mixer pipes or mixer hoses through which the beverage flows in series, in each of which a number, preferably a plurality, of static mixers are arranged.

It has been shown that, if the mixer pipes or mixer hoses are sufficiently long and thus the static mixers through which the fluid flows are sufficiently long, despite the relatively small surface area compared to known impregnators, a solution of the impregnating gas in the beverage precursor that is sufficient for beverage impregnation can be achieved in many cases without clogging occurring, because static mixers are generally less prone to clogging than known inline impregnators due to their relatively large liquid passages compared to conventional beverage impregnators.

Static mixers designed as static grid mixers with intersecting bars have proven to be particularly suitable, as they are not prone to clogging, especially when made of plastic, and are not expensive. In tests, such static grid mixers with a diameter and length of 9-10 mm, in particular with 18 bars in 6 layers, a bar thickness of 1 mm, made of polyamide, and a corresponding inner diameter of the number of mixer pipes or hoses, have proven to be advantageous.

This means that the mixer pipes or mixer hoses can also be manufactured extremely cost-effectively as plastic elements, in particular plastic pipes, in the pressure range commonly used for beverage preparation, resulting in an impregnation arrangement that is less prone to clogging, easy to clean, and cost-effective.

The beverage preparer may have a housing, approximately the size of a PC housing. If the installation space in the beverage preparer or the housing is insufficient for adequate impregnation or for the arrangement of a sufficient number or length of static mixers, a plurality of mixer pipes or hoses connected in series in a zigzag pattern with 180° elbow pipes can be arranged in a space-saving manner so that even in small installation spaces, the mixer pipes or hoses can be arranged in a space-saving manner in order to provide the length of mixer pipes or hoses equipped with static mixers required for impregnation even in small installation spaces.

It is particularly advantageous in terms of achieving a good impregnation result while at the same time achieving cost advantages through the use of static mixers if the impregnation arrangement has a circulation line that is returned downstream of the number of mixer pipes or-hoses around the number of mixer pipes or-hoses and flows into the beverage precursor product supply line or the beverage supply line upstream of the number of mixer pipes or mixer hoses. It would also be conceivable to feed the circulation line directly back into the impregnation arrangement on the inlet side. In this way, the recirculated gas-liquid mixture can be sent through the number of mixer pipes or mixer hoses with the static mixers again in order to dissolve further gas particles in the liquid.

It is advantageous to provide a circulation pump with which the gas-liquid mixture can be conveyed back through the circulation line to the inlet side of the impregnation arrangement. The circulation pump can be controlled, for example, in response to the opening of a tap provided for dispensing the beverage, such that circulation starts as soon as the tap is opened and, if necessary after a certain after-run time, stops as soon as the tap is closed. However, the circulation pump can also be controlled in response to signals from a flow meter in the beverage precursor product supply line or the beverage supply line. Advantageously, the circulation pump is switched on as soon as a flow is detected and switched off after an after-run time following the end of the detected flow has elapsed, for example an after-run time of 20 seconds.

The internal circulation cycle achieves a very high level of impregnation gas binding in the beverage, especially at warm temperatures and with high CO₂ demand values, such as during the carbonation of wine.

Particularly good impregnation results are achieved when, downstream of the number of mixer pipes or hoses, whereby an interior space of the mixing tank is connected via the tank inlet to the number of mixer pipes or hoses, via the tank outlet to the beverage outlet line, and via the circulation connection to the circulation line. This is because in this mixing tank, which is located downstream of the static mixer used to impregnate the gas into the beverage precursor, the proportion of the gas-beverage precursor mixture to be circulated can be returned to the circulation line without adversely affecting the impregnation process.

It is particularly advantageous if the outlet to the circulation line opens relatively high up in the mixing tank towards the inside of the tank, while the outlet to the beverage outlet line/tap is located far down. This is because, as tests have shown, unbound impregnation gas will accumulate in the upper part of the mixing tank and then be fed into the circulation instead of the tap.

It is advantageous if the mixing tank has an elongated shape and is arranged with a longitudinal axis extending in the vertical direction or at least with a predominantly vertical component, so that a relatively high gas bubble of unbound impregnating gas forms in the upper part of the tank interior, which can then be returned to the circulation line.

The mixing container does not need to have a large volume, which is advantageous in terms of low installation space requirements. A volume of <500 ml, preferably 150 ml to 300 ml, is sufficient.

It is also advantageous for good impregnation results if the tank inlet opening into the tank interior is located at a height between the opening to the tank outlet and the opening to the circulation connection, preferably at approximately half the height between them. This ensures that the incoming gas-beverage precursor mixture is neither immediately sucked into the beverage outlet nor immediately back into the circulation line. In other words, the unbound impregnation gas in the mixing tank has the opportunity to accumulate at the top of the tank interior.

In the event that, despite circulation, an excess of unbound gas forms during the use of static mixers for impregnating the beverage precursor with impregnating gas, for example because more impregnating gas is used than can be bound into the beverage precursor, it is also advantageous if the impregnation arrangement downstream of the number of mixer pipes or hoses and preferably the mixing tank has an additional vent outlet. In order to ensure that the gas discharged through the vent outlet is as pure as possible, it is advantageous for the vent outlet to open as high up as possible on the mixing tank towards the inside of the tank, preferably also above the opening of the circulation connection to the inside of the tank, so that it is ensured that the residual impregnation gas accumulating at the top of the mixing tank is discharged through the vent outlet. The vent line penetrating the tank wall can be equipped with a vent valve, preferably an electronically controllable solenoid valve, so that the venting function can be controlled via the beverage perparer's control system.

The elongated, upright mixing tank can be designed particularly simply as an upright hollow piston, which is provided with a tank cap, preferably screwed on, whereby the screw connection is further preferably sealed against the environment by a sealing ring. An inlet connection pipe, a circulation connection line and, preferably, also a vent connection line can be led into the mixing tank, whereas the tank outlet has a tank outlet line that preferably penetrates the tank wall of the mixing tank at the bottom of the tank, the opening of which on the tank interior side opens directly at or at least near the bottom of the mixing tank towards the tank interior.

The tank inlet line of the tank inlet, on the other hand, advantageously opens into the tank interior at approximately half the height of the tank interior and, if it is routed through the tank cap, can protrude downwards from the tank cap by a corresponding distance. However, a lateral inlet into the mixing tank at half the height of the mixing tank would also be conceivable. It has been shown that a horizontal opening towards the tank interior is advantageous for good stratification in the mixing tank when the unbound impregnating gas is discharged upwards. The circulation connection line of the circulation connection can also be routed through the tank cap and protrude downwards to a certain extent so that it opens below the optional vent line but above the opening of the tank inlet to the tank interior. It may be advantageous to provide a perforation in the pipe wall of the downwardly protruding pipe connection of the circulation connection line so that unbound impregnating gas can be discharged back into the circulation line in the area where the gas bubble forms.

In order to convey the beverage precursor product into the impregnation arrangement and the finished impregnated beverage out of the impregnation arrangement to the dispensing point, i.e., usually to the tap, the beverage preparer may have a beverage pump. In the beverage sector, beverage pumps driven by pressurized gas, such as diaphragm pumps, are common. However, in terms of better controllability via an electronic control unit of the beverage preparer, it has proven advantageous to use an electrically driven beverage pump as the beverage pump. In particular, a so-called BLDC beverage pump, i.e., a beverage pump driven by a brushless DC motor. This would allow the beverage perparer to be operated with rechargeable batteries and thus independently of the power grid.

To control the beverage pump, a pressure gauge can be provided in the beverage precursor product supply line, the beverage line, or in the beverage outlet line in order to be able to control the beverage pump to a desired system pressure in the beverage preparer. A flow meter may also be provided as an advantage to control the beverage pump to the desired volume flow. The control may be implemented in a control unit realized, for example, as a microcontroller. A display for visualizing system states, error messages, and sensor values may also be provided.

Finally, the beverage preparer may have a gas dosing device for dosing impregnation gas as closely fitting as possible to the volume flow of the beverage precursor prodcut, as is known in principle from our own German patent DE 10 2015 010 783 B3, which is fully incorporated herein in this regard. The gas dosing device can be controlled by the same control unit as the rest of the system.

Further advantageous further developments of the invention are explained in more detail on the basis of the embodiment shown in the accompanying drawings. They show:

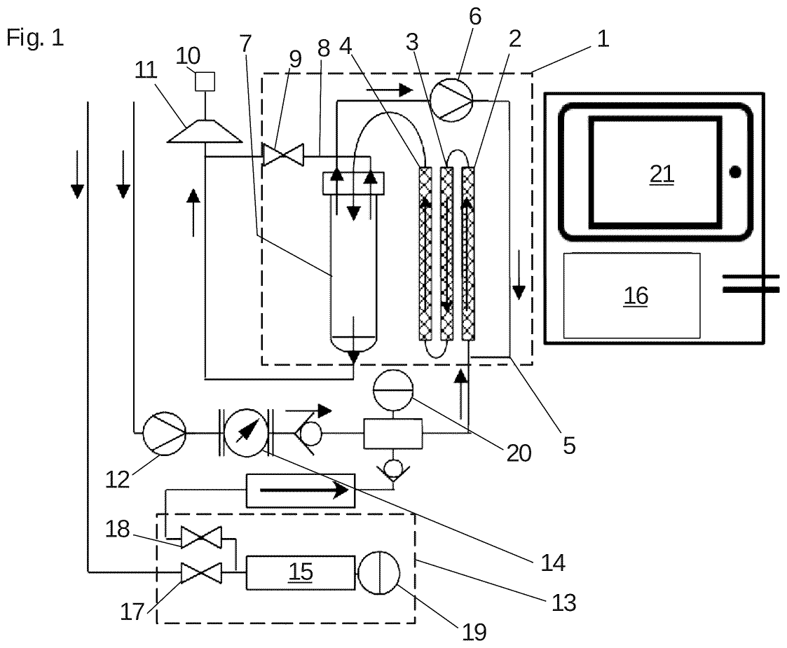

FIG. 1: an embodiment of the beverage preparer according to the invention as a block diagram; and

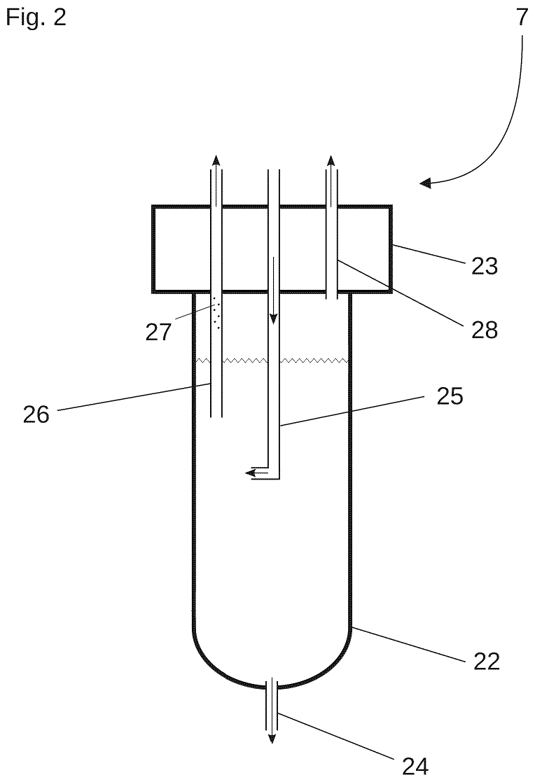

FIG. 2: a detailed view of a mixer tank of the beverage preparer shown in FIG. 1;

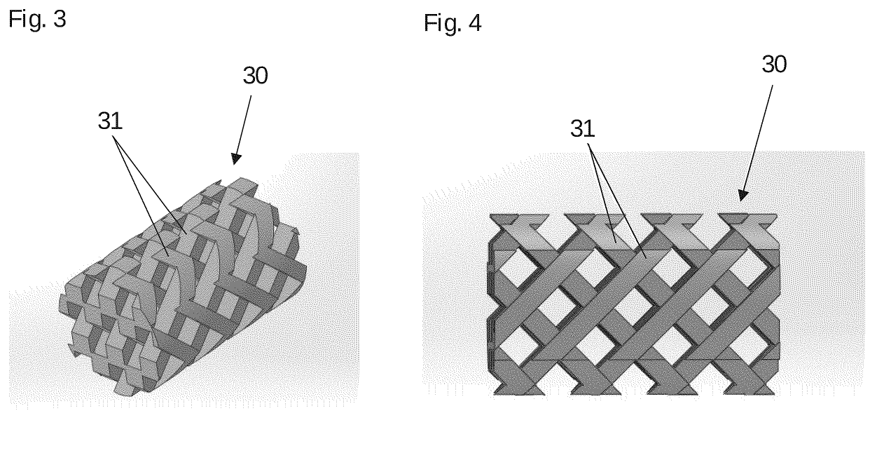

FIG. 3: a static mixer for arrangement in a mixer pipe or mixer hose of the beverage preparer shown in FIG. 1 in perspective view; and

FIG. 4 a side view of the static mixer shown in FIG. 3.

FIG. 1 schematically shows a beverage preparer with an impregnation arrangement designated as a whole by reference sign 1. The impregnation arrangement has three mixer pipes or mixer hoses 2, 3, 4 arranged next to each other, which are connected on the inlet side to a beverage supply line and to each other in series via elbows. A tank inlet line is connected to the in terms of flow last mixer pipe or mixer hose 4 on the outlet side, which leads into a mixer tank 7 of the impregnation device 1.

In the mixer pipes or mixer hoses 2, 3, 4, preferably plastic pipes, static mixers, in particular static grid mixers, are arranged as indicated by the dotted grid lines, in the preferred embodiment static grid mixers with a diameter of 9.4 mm and a length of 9.4 mm, each with 18 bars or webs in 6 layers with a web thickness of 1 mm.

Such a static mixer 30 is shown in detail in FIGS. 3 and 4. It has intersecting bars 31 which narrow the space available as a passage for the liquid to be impregnated and cause the flow path to meander, resulting in mixing and impregnation.

The mixer tubes or hoses 2, 3, 4 have a corresponding inner diameter and a preferred length of approx. 150 to 250 mm, so that a plurality of static mixers can be arranged in each of the three mixing tubes or hoses 2, 3, 4 shown. Of course, several or fewer mixer tubes or mixer hoses with greater or lesser lengths may also be provided. Likewise, the diameter of the tubes or hoses may vary, as long as the static mixers also have a corresponding diameter. Only one corresponding mixer tube may also be provided. However, the embodiment shown has proven to be space-saving, which is a decisive criterion for beverage preparers of the type according to the invention, which are often housed in small enclosures the size of shoe boxes or PC enclosures.

The mixer tank 7 is shown in detail in FIG. 2. The tank inlet, which is connected on the inlet side to the outlet of the downstream mixer tube 4, has a tank inlet line 25 which passes through a tank cover 23 at approximately half the height of the tank interior or internal volume and is bent there by 90° so that the inlet into the tank interior is horizontal.

The mixer tank 7 is formed by a vertically arranged hollow piston 22 onto which the tank cap 23 is screwed. At the bottom of the hollow piston 22 there is a tank outlet with a tank outlet line 24 leading through the tank wall, which connects the mixing tank to a pipe leading to the beverage dispensing point, i.e., usually to the tap. A circulation connection line 26 also leads through the tank cap 23 at the top into the interior of the tank to a height above the junction of the tank inlet line 25. In the area near the tank cap 23, the circulation connection line 26 is perforated with gas intake holes 27. Furthermore, a vent connection line 28 also leads optionally through the tank cap 23 into the interior of the tank.

The circulation connection line 26 ends above the opening of the tank inlet line 25 on the inside of the tank at approximately ⅔ of the height of the tank interior. The vent connection line 28 ends on the inside at the tank cap 23 and thus still above the circulation connection line 26.

The circulation connection line 26 is connected to a circulation line 5, via which part of the gas-liquid mixture can be circulated back to the inlet side of the mixer pipes 2, 3, 4. A circulation pump 6 is provided for this purpose, which is controlled in response to signals from a flow meter 14 further upstream in a supply line for the beverage precursor product to be impregnated.

The tank outlet line 24 is connected via an optional pressure reducer 11 to a dispensing line leading to a tap 10. The vent connection line 28 is connected to a vent line 8, which is equipped with a vent valve 9 and opens into the dispensing line downstream of the pressure reducer 11. The vent valve 9 can also be controlled in response to signals from the flow meter 14, for example so that a venting phase follows after completion of a dispensing process.

Upstream of the flow meter 14, a beverage pump 12, advantageously designed as a BLDC beverage pump, is provided to convey the beverage precursor product to be impregnated from a beverage precursor product source, e.g., an unpressurized beverage bag, through the beverage precursor product supply line and then further through the entire beverage dispenser system to the tap. The beverage pump 12 can also be controlled in response to signals from the flow meter 14 and/or a pressure meter 20 downstream of the flow meter 14 and/or signals from the tap.

For dosing the impregnating gas into the supplied beverage precursor product, a gas dosing device 13 is provided which doses the supply of the impregnating gas coming from a pressurized gas source (e.g., gas cylinder) into the beverage precursor product in accordance with the volume flow of the beverage precursor product detected by the flow meter 14. The gas dosing device 13 comprises an impregnating gas buffer storage tank 15 with a connected pressure and optional temperature meter 19. The gas buffer storage tank 15 can be loaded with an inlet valve 17 and an outlet valve 18 and discharged to the impregnation arrangement 1, in a manner clocked to the liquid flow. Using the general gas equation, the pressure gauge 19 and the clock rate of the valves 17, 18 can be used to measure and control the amount of impregnation gas added to the beverage precursor product per unit of volume.

Downstream of the gas dosing device, an additional impregnation gas buffer storage tank is optionally provided to smooth out gas surges. The impregnating gas supply line then joins the beverage precursor product supply line further downstream to form a beverage line that flows into the impregnation assembly 1, with check valves upstream of the junction preventing unwanted inflow of impregnating gas into the beverage precursor supply line and of liquid into the impregnating gas supply line. Downstream of this, the circulation line 5 joins the beverage line so that the returned liquid-gas mixture is sent through the impregnation arrangement 1 again.

To control the beverage pump 12, the gas dosing device 13, the circulation pump 6, and the vent valve 9, a control unit 16, advantageously designed as a microcontroller, is provided, to which a display 21 for displaying system states, error messages, etc. can also be connected.

Advantageous further developments and modifications of the embodiment shown are possible without departing from the scope of the invention.

1. A beverage preparer, suitable for preparing a beverage from a beverage precursor product that is free of or low in impregnating gas and a number of impregnation gases, comprising:
an impregnating gas supply line for supplying the number of impregnating gases and a beverage precursor product supply line for supplying the beverage precursor product to an impregnation arrangement, wherein the impregnating gas supply line and the beverage precursor product supply line open into the impregnation arrangement at its inlet or merge upstream of the impregnation arrangement to form a beverage supply line which opens into the impregnation arrangement at its inlet, with
the impregnation arrangement for dissolving the number of impregnating gases in the beverage precursor product to form the beverage, wherein the impregnation arrangement has a number of mixer pipes or mixer hoses arranged in series in the direction of flow, in each of which a number of static mixers is arranged, and with
at least one or an electronically controlled beverage dispenser, which is connected to the impregnation arrangement via a beverage outlet line coming from the outlet side of the impregnation arrangement.

2. The beverage according to claim 1, wherein the impregnation arrangement has a circulation line which returns from downstream of the number of mixer pipes or hoses around the number of mixer pipes or mixer hoses and, upstream of the number of mixer pipes or mixer hoses, into the beverage precursor product supply line, or the beverage supply line or directly into the impregnation arrangement , wherein a circulation pump acting on the circulation line is provided.

3. The beverage preparer according to claim 1, wherein the beverage preparer has a beverage pump for conveying the beverage precursor product from a beverage precursor container at least into the beverage precursor product supply line or all the way to the tap or to the beverage dispenser, and wherein the beverage pump is preferably a BLDC beverage pump, wherein the beverage pump is controlled in response to signals from a flow meter in the beverage precursor product supply line or the beverage supply line and/or a pressure meter downstream of the flow meter and/or signals from the tap.

4. The beverage preparer according to claim 1, wherein the beverage preparer comprises a gas dosing device which serves to dose the impregnating gas into the beverage precursor product in a ratio desired for the beverage, and a device for determining the volume of beverage precursor product supplied to the impregnation arrangement per unit of time, wherein the gas dosing device has an impregnating gas buffer storage, a gas dosing device inlet for connection to a pressurized gas container, and a gas dosing device outlet connected to a gas dosing device outlet line leading into the beverage precursor product supply line, and wherein an inlet valve is provided for opening and closing the gas dosing device inlet, and an outlet valve is provided for opening and closing the gas dosing device outlet, and wherein a control is also provided which opens and closes the inlet valve and the outlet valve with staggered timing in accordance with the volume flow detected by the determining device.

5. The beverage preparer according to claim 1, wherein the number of mixer pipes or mixer hoses arranged in series in the direction of flow comprises a plurality of plastic mixer pipes zickzack-connected in series with 180° bend conduits arranged next to each other arranged side by side and connected in series in a zigzag pattern with 180° elbow pipes, or that the number of mixer hoses arranged in series one after the other in the direction of flow comprises a mixer hose bent several times by 180°.

6. The beverage preparer according to claim 5, wherein each static mixer is designed as a static mixer with a grid of intersecting bars made of plastic.

7. The beverage preparer according to claim 6, wherein a plurality of static mixers are arranged in each of the mixer pipes or hoses.

8. The beverage preparer according to claim 2, wherein the impregnation arrangement downstream of the number of mixer pipes or mixer hoses has a mixer tank with a tank inlet, a tank outlet, and a circulation connection, wherein the interior of the tank of the mixer tank is connected via the tank inlet to the number of mixer pipes or mixer hoses, via the tank outlet to the beverage outlet line and via the circulation connection to the circulation line.

9. The beverage preparer according to claim 8, wherein the tank outlet comprises a tank outlet line penetrating a tank wall of the mixer tank with an external opening and a tank interior side opening, wherein the tank interior side opening of the tank outlet line opens into the interior of the tank at or near a bottom side of the mixer tank.

10. The beverage preparer according to claim 9, wherein the tank inlet comprises a tank inlet line penetrating the tank wall of the mixer tank with an external opening and a tank interior side opening, wherein the tank interior side opening of the tank inlet line opens into the interior of the tank above the tank interior side opening of the tank outlet line, advantageously at approximately half the height of the interior of the tank and preferably in a horizontal direction.

11. The beverage preparer according to claim 10, wherein the circulation connection comprises a circulation connection line (26) penetrating the tank wall of the mixer tank with an external opening and a tank interior side opening, wherein the tank interior side opening of the circulation connection line opens into the interior of the tank above the tank interior side opening of the tank outlet line and above the tank interior side opening of the tank inlet line, preferably at approximately two-thirds of the height of the interior of the tank.

12. The beverage preparer according to claim 11, wherein the circulation connection line is perforated with gas intake holes above the tank interior side opening of the tank inlet line.

13. The beverage preparer according to claim 11, wherein the mixer tank has an additional vent outlet with a vent outlet line penetrating the tank wall of the mixer tank, wherein the tank interior side opening of the vent outlet line opens up at or near the top of the mixer tank into the interior of the tank, and wherein the interior of the tank is connected to a vent line via the vent outlet line.

14. The beverage preparer according to claim 11, wherein the mixer tank has an elongated shape with a longitudinal axis extending in the vertical direction or with a predominantly vertical component, wherein the mixer tank has a standing hollow piston with an outlet on the underside, wherein the hollow piston is provided with a tank cap, preferably screwed on, through which the tank inlet line, the circulation connection line and, preferably, the vent line are led into the mixer tank.

15. The beverage preparer according to claim 1, wherein a control unit, advantageously designed as a microcontroller, is provided for controlling the beverage pump, the gas dosing device, the circulation pump and/or a vent valve in the vent line, a control unit.

16. The beverage preparer according to claim 2, wherein the circulation pump is controlled in response to the opening of the tap so that circulation starts as soon as the tap is opened and, if necessary after a certain after-run time, stops as soon as the tap is closed.

17. Beverage preparer according to claim 16, wherein the circulation pump is controlled in response to signals from the flow meter in the beverage precursor product supply line or the beverage supply line.

18. The beverage preparer according to claim 17, wherein the circulation pump is controlled so that it is switched on as soon as a flow is detected and switched off after an after-run time following the end of the detected flow has elapsed, for example an after-run time of 20 seconds.

19. The beverage preparer according to claim 15, wherein the beverage preparer is suitable for an alcohol-infused fruit pulp, an alcohol-infused fruit syrup, or an alcoholic mixed beverage such as espresso martini or wine as a beverage precursor product and N2 and/or CO2 as impregnating gas to form a mixed alcoholic beverage or a sparkling wine as a beverage.
